(19) United States
(12) Patent Application Publication
(10) Pub. No.: US 2014/0006046 A1
(43) Pub. Date: Jan. 2, 2014

(54) Survey System for Improving Regimen Adherence

(71) Applicants: Steven R. Feldman, Winston-Salem, NC (US); Brad Alan Yentzer, Winston-Salem, NC (US); Jenna L. O'Neill, Winston-Salem, NC (US)

(72) Inventors: Steven R. Feldman, Winston-Salem, NC (US); Brad Alan Yentzer, Winston-Salem, NC (US); Jenna L. O'Neill, Winston-Salem, NC (US)

(21) Appl. No.: 13/994,430

(22) PCT Filed: Jan. 13, 2012
(86) PCT No.: PCT/US12/21193

§ 371 Date: Sep. 17, 2013

Related U.S. Application Data
(60) Provisional application No. 61/432,953, filed on Jan. 14, 2011.
(60) Provisional application No. 61/468,108, filed on Mar. 28, 2011.

(51) Int. Cl. G06F 19/00

(52) U.S. Cl. CPC G06F 19/36
USPC 705/2

(57) ABSTRACT

Systems, apparatus and methods for improving subject adherence to a regimen are provided. In some embodiments, the method comprises (a) assigning at least one subject to a survey group, wherein each subject is to participate in a regimen on a regular regimen schedule; then (b) transmitting a survey prompt to each of said subjects on a regular survey schedule so that said subject is prompted to complete a survey regarding their use of and/or the outcome of the regimen; (c) receiving a survey response from those of said subjects who respond to said survey prompt; and (d) performing step (b) to (c) on one or more occasions, so that subject adherence to said regimen is enhanced.

### BACKGROUND OF THE INVENTION

A number of topical agents are effective for the treatment of mild to moderate acne.(1) Despite the substantial physical and psychological morbidity associated with acne, patients often do not use their medications as prescribed. This non-adherence is a significant cause of acne treatment failure.(2-4) Patients may find topical treatments to be unpleasant, time-consuming, and ineffective, which may lead to poor adherence.(5;6) However, additional factors may also be involved in determining a patient's adherence behavior.

Poor adherence is a problem throughout medicine, limits patients' response to treatment and is costly to society. Various methods have been tested in clinical trials to augment adherence, such as reminder systems or financial incentives.(7;8) One recurrent theme observed is that patients increase their use of medication around the time of office visits, a phenomenon known as ‘white-coat compliance.’(9) Unfortunately, frequent office visits may not be a practical or cost-effective means of improving medication compliance. Accordingly, there is a need for new ways to enhance treatment compliance.

### SUMMARY OF THE INVENTION

A first aspect of the invention is a method for improving subject adherence to a regimen, comprising:
(a) assigning at least one subject to a survey group, wherein each subject is to participate in a regimen on a regular regimen schedule; then
(b) transmitting a survey prompt to each of the subjects on a regular survey schedule so that the subject is prompted to complete a survey regarding their use of and/or the outcome of the regimen;
(c) receiving a survey response from those of the subjects who respond to the survey prompt; and
(d) performing step (b) to (c) on one or more occasions, so that subject adherence to the regimen is enhanced.

A second aspect of the invention is a system for improving subject adherence to a regimen, comprising:
(a) means for assigning at least one subject to a survey group, wherein each subject is to participate in a regimen on a regular regimen schedule;
(b) means for transmitting a survey prompt to each of the subjects on a regular survey schedule so that the subject is prompted to complete a survey regarding their use of and/or the outcome of the regimen;
(c) means for receiving a survey response from those of the subjects who respond to the survey prompt; and
(d) means for performing step (b) to (c) on one or more occasions, so that subject adherence to the regimen is enhanced.

In some embodiments of the foregoing, adherence to the regimen by the subjects receiving the survey prompt is at least 20, 30, 40 or 50 percent greater (e.g., as determined 4, 5, 6, 7 or 8 weeks after first receipt of the survey prompt) as compared to control subjects assigned the same regimen who do not receive the survey prompt.

In some embodiments of the foregoing, the regimen is a treatment regimen for a condition with which the subject is afflicted.

In some embodiments of the foregoing, the treatment regimen is an exercise regimen, drug regimen, or combination thereof.

In some embodiments of the foregoing, the condition is a dermatological condition and the treatment is a topical treatment.

In some embodiments of the foregoing, the regimen is carried out once or twice daily for at least 4 weeks or 8 weeks.

In some embodiments of the foregoing, the survey schedule is once or twice weekly for 4 to 8 weeks.

In some embodiments of the foregoing, the step of transmitting a survey prompt is carried out by automated transmission of an internet or telephone message.

In some embodiments of the foregoing, the step of receiving a survey response is carried out by automated processing of an internet or telephone survey.

In some embodiments of the foregoing, the assigning step further comprises: alerting each of the subjects of the availability of the reward.

Some embodiments of the foregoing, further comprise (e) determining from the survey responses those subjects who have completed the internet-based survey in at least a predetermined number of occasions; and then (f) notifying those subjects who have completed the survey on at least the predetermined number of occasions of their receipt of a first reward.

In some embodiments of the foregoing, the predetermined number of occasions is at least ¾ of the total number of surveys in the survey schedule.

In some embodiments of the foregoing, the assigning step further comprises alerting each of the subjects of a chance of receiving a second reward, and the notifying step further comprises notifying a subset of those subjects receiving the first reward of their receipt of the second reward.

In some embodiments of the foregoing, the reward is not based on the subject participating in a regimen. In some embodiments of the foregoing, the at least one subject comprises a plurality of subjects undergoing treatment by a common health care provider.

The foregoing and other objects and aspects of the present invention are explained in greater detail in the drawings herein and the specification set forth below.

### BRIEF DESCRIPTION OF THE DRAWINGS

FIG. 1. Schematic diagram of an embodiment of a system and method of the invention.

FIG. 2. Internet Survey used to carry out an illustrative embodiment of the invention.

FIG. 3. Consort Diagram for an illustrative embodiment of the invention.

FIG. 4. Box-plot of Adherence. Adherence behaviors differed significantly between the 2 groups. These box plots illustrate the mean adherence with 75^{th} and 25^{th} percentiles. The error bars represent the min-max range.

FIG. 5. Mean Adherence Over Time. Note that, with the exception of week 1, the difference in adherence was statistically significant at all time points (Kruskal-Wallis, P<0.05).

FIG. 6. An example of a survey display of the present invention.

FIG. 7. An example data processing system that may be included in devices operating in accordance with some embodiments of the present invention.

### DETAILED DESCRIPTION OF EMBODIMENTS OF THE INVENTION

The present invention now will be described more fully hereinafter with reference to the accompanying figures, in which embodiments of the invention are shown. This invention may, however, be embodied in many alternate forms and should not be construed as limited to the embodiments set forth herein. Like numbers refer to like elements throughout the description of the figures.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein the term “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and this specification and will not be interpreted in an idealized or overly formal sense unless expressly so defined herein.

The present invention may be embodied as systems, methods, and/or computer program products. Accordingly, the present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any non-transient medium that can contain or store the program for use by or in connection with the instruction execution system, apparatus, or device.

The computer-usable or computer-readable medium may be, for example but not limited to, an electronic, magnetic, electromagnetic, infrared, or semiconductor system, apparatus, or device. More specific examples (a nonexhaustive list) of the computer-readable medium would include the following: an electrical connection having one or more wires, a portable computer diskette, a random access memory (RAM), a read-only memory (ROM), an erasable programmable read-only memory (EPROM or Flash memory), and a portable compact disc read-only memory (CD-ROM).

The present invention is described below with reference to block diagrams and/or flowchart illustrations of devices, methods and computer program products according to embodiments of the invention. It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved.

### 1. Definitions

“Subjects” or “patients” as used herein are, in general, male or female human subjects of any suitable age, including juvenile, adolescent, adult, and geriatric subjects. In some embodiments, adolescent subjects are preferred.

“Regimen” as used herein includes exercise or practice regimens for performances such as sports, dance, and musical instruments; exercise regimens for treatment of a medical condition; treatment regimens for a medical condition with a pharmaceutical agent, drug or medical device; cognitive, behavioral, or other psychological treatments for a medical or psychological condition, etc.

“Condition” as used herein may be any infection, disorder, disease, etc. for which medical treatment may be sought, including but not limited to hypertension or high blood pressure, hypercholesterolemia, heart disease, coronary artery disease, diabetes, obesity, addictive behaviors such as smoking, excessive eating, alcohol consumption, drug abuse, gambling, etc. In some embodiments the condition is a dermatological condition such as acne, eczema, psoriasis, dandruff, or the like. Additional conditions include, but are not limited to, psychiatric disorders such as anxiety, depression, post-traumatic stress disorder, bipolar disorder, etc; neurological disorders such as multiple sclerosis, amyotrophic lateral sclerosis, Parkinson's disease, Alzheimer's disease, etc.; respiratory disorders such as asthma, cystic fibrosis, chronic bronchitis, emphysema, chronic obstructive pulmonary disease (COPD), etc.; infectious diseases and/or chronic infections such as herpes virus infection, HIV/AIDS, fungal and yeast infections, staphlococcus aureus infections, etc.; benign and malignant hyperproliferative disorders such as skin cancer (e.g., squamous-cell carcinoma, basal-cell carcinoma), lung cancer, breast cancer, colon cancer, psoriasis, solar keratosis, ichthyosis, Grover's disease, common warts, keratoacanthoma, seborrhoeic keratosis, scleroderma, seborrhea, etc.

“Pharmaceutical agent” as used herein refers to any prescription or non-prescription drug which may be employed in treating a condition in a subject in need thereof. In some embodiments, the “pharmaceutical drug” may be a candidate drug or a control (placebo) agent, in a clinical trial. In some embodiments, the pharmaceutical agent is an oral or topical pharmaceutical agent (that is, an orally administered or topically administered pharmaceutical agent, including intranasal and ophthalmologic agents). In some embodiments, the pharmaceutical agent is a parenterally injectable pharmaceutical agent (e.g., a subcutaneous, intramuscular, or intraveneous injectable agent). In some embodiments, the pharmaceutical agent is administered by inhalation. Pharmaceutical agents with which the present invention is concerned are, in general, those which are self-administered by the patient or subject. Non-limiting examples of pharmaceutical agents are set forth below.

“Medical device” as used herein includes any medical device used to treat or monitor a condition, including but not limited to inhalers, pumps such as insulin pumps, electrical stimulators such as transcutaneous electrical nerve stimulators (TENS devices), monitors such as blood glucose and blood pressure monitors, compression garments (e.g. compression hosiery used in treating swelling accompanying heart failure), etc.

“Regimen schedule” as used herein refers to the timing on which a particular behavior is to be performed (e.g., exercise such as cardiovascular exercise, practice of a (gross or fine) motor skill, self-administering a pharmaceutical agent, etc.), or an interval of time during which a particular behavior (e.g., an addictive, obsessive, or compulsive behavior such as smoking, alcohol consumption, drug abuse, gambling, etc.) is to be avoided. Typical schedules are to perform the particular behavior once, twice, or three times a day; or avoid the particular behavior for an interval of time such as one, two, or three days, for any suitable duration (e.g. one, two or three weeks up to one, two or three months or more).

“Treatment schedule” as used herein refers to the timing on which a particular pharmaceutical agent is prescribed by the physician, and/or instructed by the manufacturer or other health professional, to be taken by the subject undergoing treatment. Typical treatment schedules can vary and may be once, twice, or three times a day, once, twice, or three times a week, or once, twice or three times a month for any suitable duration (e.g. one, two or three weeks up to one, two or three months, a year, or more).

“Survey prompt” as used herein refers to the act of reminding a subject that they should complete a survey, and may be transmitted by any suitable means. A survey prompt can be transmitted in writing by mail, or as a personal phone call. In a preferred embodiment, the survey prompt is transmitted electronically and automatically: for example, the survey prompt may be transmitted by telephone (e.g., as a text message or automated voice message), as an internet message (as an email, instant text message, instant audio or video message, etc.), or any other suitable means. In some embodiments, the automated message contains a link to the survey form itself (e.g., a link to a web page on which the survey is completed).

“Survey response” as used herein refers to the completion of a questionnaire, and may be received by any suitable means. A written survey response can be received by mail; a spoken survey response can be personally transcribed. In a preferred embodiment, the survey response is processed electronically and automatically: for example, the survey is carried out by transmission of a text message, by completing a web-page based survey on the internet, by spoken reply to voice-recognition software in response to automated (written or audio) questioning, either by telephone or on the internet; etc.

“Health care provider” which in some embodiments refer to any health care provider that subjects may have in common or share, including an individual physician or practice, a hospital, an exercise or diet facility or program, a nursing home or assisted living facility, etc.

### 2. Illustrative Embodiment

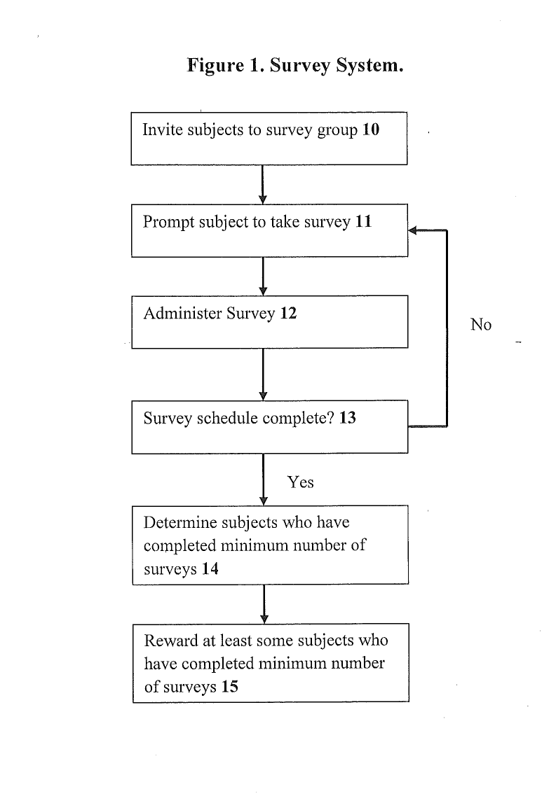

A system and method for improving drug adherence is schematically illustrated in FIG. 1. Initially, subjects are invited to participate 10 in a survey. Each of the subjects is undergoing (before or after assignment) treatment with a pharmaceutical agent for a condition on a regular treatment schedule. The size of the survey group is not critical. In some embodiments, the survey group may be a single subject. However, in general, group sizes of at least 2, 5, 10 or 20, up to 100, 200, or more, are contemplated. Subjects undergoing treatment may be afflicted with the same, or a different, condition. Subjects may be assigned to the survey group at the same time, or at a different time (that is, one or more subjects may join the survey late, if desired). Subjects may “opt in” to the survey in consultation or discussion with a health care provider upon initial prescription of a particular treatment to which the survey is directed to generate a list of subjects, which list may in turn be provided to a survey administrator.

Upon agreeing to participate in the survey, the subject may optionally be advised on the availability of one or more rewards for participating in the survey. The subject may optionally be advised of the nature of the reward (e.g., cash, gift certificate, specific goods or services, etc.), rules for attaining each such reward, such as: minimal participation or minimal number of surveys completed to attain a reward, the probability of attaining a reward (e.g., the number of other members of the group, the number of rewards available, the specific numeric probability of attaining a reward, etc.).

After assignment to the survey group, each subject is transmitted 11 a survey prompt (e.g., by the survey administrator). The survey prompt may be transmitted by any suitable means, such as by a personal phone call, an automated phone call, a text message, etc. In one embodiment, each subject is transmitted an email that contains an internet link to a web page, which web page is configured to administer the survey and compile the appropriate data for carrying out the system and method of the invention.

The survey is preferably carried out or administered 12 on the internet, though other means of communication such as a cell phone may be used. The subject may use a personal computer, personal digital assistant (PDA) device or other communication device to respond to the survey. In one form, this would be to log on to a web page, which web page administers the survey. Responding by text message is an alternative form. The survey preferably contains at least 1, 2, 3, or 4 questions (preferably not more than 20 questions; and more preferably not more than 12 questions). In some embodiments, the survey may contain one or more questions from each of the following categories:
A: Frequency of compliance with regimen (e.g., drug treatment regimen)?
B: Difficult in carrying out the regimen task (e.g., using the pharmaceutical agent)?
C: Improvement in or current severity of condition or performance which the regimen is intended to enhance?
D: Responsiveness of condition, performance or ability to regimen?
E: Presence or absence of side effects (e.g., headache, nausea, insomnia, dizziness, anxiety, diarrhea, skin rashes or irritation (including non-observable irritation, such as itching or pain), abdominal pain, fatigue, sleepiness, weight gain, allergic reactions etc.).

In some embodiments, the survey includes least one question concerning a side-effect (e.g., skin irritation). The question optionally (but in some embodiments preferably) has at least one graphical depiction of the side-effect associated therewith (e.g., one, two, or three or more photographs of the side effect, for example as situated on a patient). The graphical depictions may depict a range of reactions, e.g., from mild to severe. The question may be presented in any suitable manner, such as by simply asking whether a side-effect is present, yes or no; by asking the patient to grade the severity of the side effect on a scale such as a 1 to 5 or 1 to 10 scale; and/or by asking the patient to indicate a graphical depiction that most nearly matches their side-effect or reaction. The graphical depiction may have a statement concerning the severity of the side-effect in said graphical depiction associated therewith, such as matched with the graphical depiction or matched with the question presenting the graphical depiction (e.g., a statement that the reaction is not severe and/or normal; a statement that the reaction is severe and health care should be sought; etc). In some embodiments, the statement may be worded or configured so that it provides assurance to the subject to encourage (e.g., “this is a normal reaction”; “this is not a dangerous reaction”; “you should not be discouraged by this reaction”, “this reaction is transient”, etc.) in order to encourage the subject to continue taking their medication.

The survey is preferably conducted in accordance with a predetermined schedule (e.g., 1, 2 or 3 times a week for at least 1 or 2 weeks, up to 2 or 4 months). The subject may be advised of the survey schedule at the time of enrollment and/or assignment to the survey group.

Once the survey schedule is completed 13, it is determined 14, preferably with a computer operatively associated with the web page those subjects who have completed said internet-based survey in at least a predetermined number of occasions (e.g., at least ½ or ¾ of the total number of surveys). Those subjects who receive rewards are then notified 15 of their receipt of at least one reward. Notification can be carried out by any suitable means, such as a personal or automated phone call, text message, email or the like. Rewards can be given to all subjects who complete a predetermined number of surveys, and/or a subset of those subjects who receive a “chance” at a particular reward (e.g., as assigned by a random drawing or a lottery). It is important to note that the reward is for the completion of the survey, and is not actually tied to the regimen or regimen schedule. That is, a subject could win a reward in the absence of actually partaking in the prescribed regimen. A subject's completion of the survey was found to significantly increase that subject's participation in the regimen even though the reward was not tied to compliance with the prescribed regimen.

The present invention can be implemented with any suitable software. Examples include, but are not limited to, KEYSURVEY survey software (Key Survey, 220 Forbes Road, Braintree Mass. 02184), NOVISURVEY survey software (Nov Systems, 395 Totten Pond Road, Suite 201, Waltham, Mass. 02451), SURVEYPRO 5 (Apian Software, PO Box 30046, Seattle, Wash. 98113-0046), SELECT SURVEY (ClassApps, 7111 W. 151^{st} Street, Suite 338, Overland Park, Kans. 66224), etc.

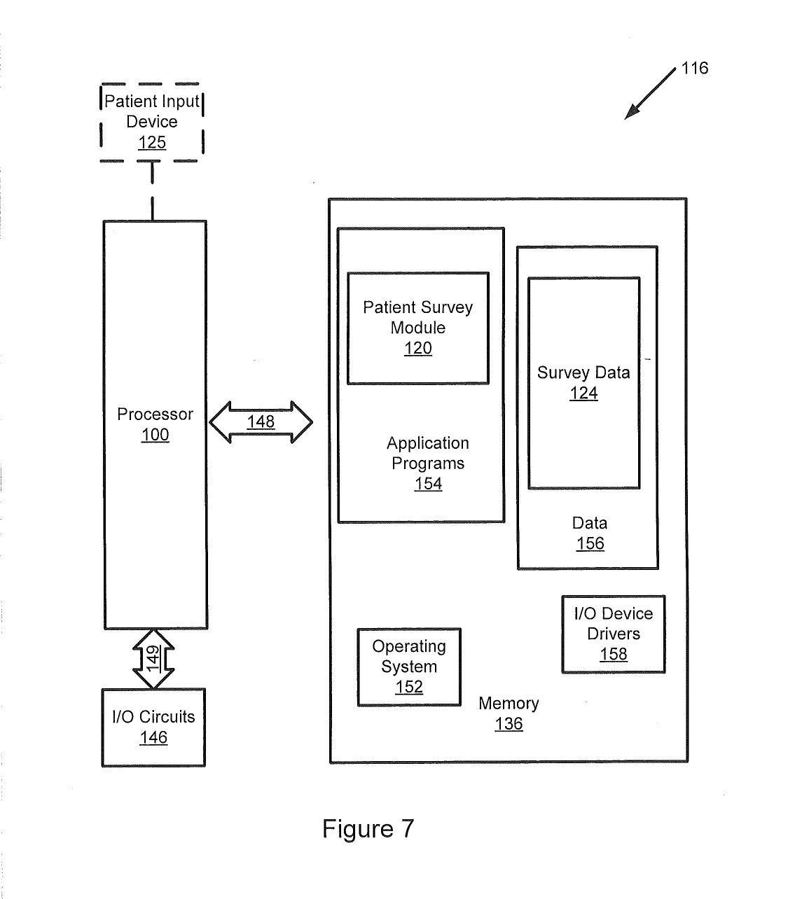

FIG. 7 illustrates an exemplary data processing system that may be included in devices operating in accordance with some embodiments of the present invention, e.g., to carry out the operations discussed herein. Numerous additional variations will be appreciated by those skilled in the art, including browser only configurations and mobile application configurations where the data is stored in the cloud.

As illustrated in FIG. 7, a data processing system 116, which can be used to carry out or direct operations includes a processor 100, a memory 136 and input/output circuits 146. The data processing system can be incorporated in a portable communication device and/or other components of a network, such as a server. The processor 100 communicates with the memory 136 via an address/data bus 148 and communicates with the input/output circuits 146 via an address/data bus 149. The input/output circuits 146 can be used to transfer information between the memory (memory and/or storage media) 136 and another component, such as a user input device 125 (e.g., a computer processor such as a mobile terminal or telecommunications device, laptop, tablet or desktop computer) for receiving user inputs. These components can be conventional components such as those used in many conventional data processing systems, which can be configured to operate as described herein.

In particular, the processor 100 can be a commercially available or custom microprocessor, microcontroller, digital signal processor or the like. The memory 136 can include any memory devices and/or storage media containing the software and data used to implement the functionality circuits or modules used in accordance with embodiments of the present invention. The memory 136 can include, but is not limited to, the following types of devices: cache, ROM, PROM, EPROM, EEPROM, flash memory, SRAM, DRAM and magnetic disk. In some embodiments of the present invention, the memory 136 can be a content addressable memory (CAM).

As further illustrated in FIG. 7, the memory (and/or storage media) 136 can include several categories of software and data used in the data processing system: an operating system 152; application programs 154; input/output device circuits 146; and data 156. As will be appreciated by those of skill in the art, the operating system 152 can be any operating system suitable for use with a data processing system, such as IBM®, OS/2®, AIX® or zOS® operating systems or Microsoft® Windows® operating systems Unix or Linux™. The input/output device circuits 146 typically include software routines accessed through the operating system 152 by the application program 154 to communicate with various devices. The application programs 154 are illustrative of the programs that implement the various features of the circuits and modules according to some embodiments of the present invention. Finally, the data 156 represents the static and dynamic data used by the application programs 154, the operating system 152 the input/output device circuits 146 and other software programs that can reside in the memory 136.

The data processing system 116 can include several modules, including a patient survey module 120 that is configured to send patient surveys, to receive survey responses and to analyze results as described herein. The modules can be configured as a single module or additional modules otherwise configured to implement the operations described herein. The data 156 can include survey data 124, for example, that can be used by the survey module 120 to collect and analyze survey results and/or to send survey questions to the user input device 125.

While the present invention is illustrated with reference to the patient survey module 120 and the survey data 124 in FIG. 7, as will be appreciated by those of skill in the art, other configurations fall within the scope of the present invention. For example, rather than being an application program 154, these circuits and modules can also be incorporated into the operating system 152 or other such logical division of the data processing system. Furthermore, while the survey module 120 in FIG. 7 is illustrated in a single data processing system, as will be appreciated by those of skill in the art, such functionality can be distributed across one or more data processing systems. Thus, the present invention should not be construed as limited to the configurations illustrated in FIG. 7, but can be provided by other arrangements and/or divisions of functions between data processing systems. For example, although FIG. 7 is illustrated as having various circuits and modules, one or more of these circuits or modules can be combined, or separated further, without departing from the scope of the present invention. In some embodiments, the user input device 125 may be integrated with the memory 136, processor 100, and I/O circuits 146 such that some or all of the functions of the patient survey module 120 may be performed on the user device. In some embodiments, the user input device 125 may be in communication with the memory 136, processor 100 and I/O circuits 146 via a computer network, such as the Internet, wired and/or wireless communications connections.

### 3. Pharmaceutical Agents

Additional non-limiting examples of pharmaceutical agents on which the present invention may be practiced include those set forth below.

Analgesics. Analgesics (and headache medications) that can be used in carrying out the combination methods of the present invention include, but are not limited to: non-steroidal anti-inflammatory drugs (NSAIDs), including salicylates (e.g., Aspirin (acetylsalicylic acid), Diflunisal, and Salsalate); propionic acid derivatives (e.g., Ibuprofen, Naproxen, Fenoprofen, Ketoprofen, Flurbiprofen, Oxaprozin, and Loxoprofen), acetic acid derivatives (e.g., Indomethacin, Sulindac, Etodolac, Ketorolac, Diclofenac, and Nabumetone), enolic acid (Oxicam) derivatives (e.g., Piroxicam, Meloxicam, Tenoxicam, Droxicam, Lornoxicam, and Isoxicam), fenamic acid derivatives (e.g., Mefenamic acid, Meclofenamic acid, Flufenamic acid, and Tolfenamic acid), selective COX-2 inhibitors (e.g., Celecoxib, Rofecoxib, Valdecoxib, Parecoxib, Lumiracoxib, Etoricoxib, and Firocoxib), sulphonanilides (e.g., Nimesulide); opiates and opioids, including natural opiates (e.g., morphine, codeine, and thebaine), Semi-synthetic opioids (e.g., heroin, hydromorphone, hydrocodone, oxycodone, oxymorphone, desomorphine, nicomorphine, dipropanoylmorphine, benzylmorphine and ethylmorphine and buprenorphine) Fully synthetic opioids (e.g., fentanyl, pethidine, methadone, tramadol and dextropropoxyphene) opioid peptides (e.g., endorphins, enkephalins, dynorphins, and endomorphins) tramadol, tapentadol, etc; flupertine; Antihistamines such as hydroxyzine and diphenhydramine; Corticosteroids such as prednisone), dexamethasone and methylprednisolone; Depacon; Dihydroergotamine (DHE-45); Ergotamines; Magnesium; Muscle relaxants such orphenadrine, baclofen, metaxalone, cyclobenzaprine), carisoprodol, chlorzoxazone, tizanidine and orphenadrine; Phenothiazines such as droperidol, promethazine, and prochlorperazine; Triptans such as sumatriptan, rizatriptan, zolmitriptan, almotriptan, eletriptan, frovatriptan, and naratriptan; Beta-blockers such as propranolol, nadolol, bystolic, atenolol and metroprolol); Botox (botulinum); Calcium channel blockers such as verapamil and nimodipine; Dopamine reuptake inhibitors such as as bupropion; Selective serotonin reuptake inhibitors (SSRIs) such as luoxetine, paroxetine, setraline, citalopram and escitalopram; Serotonin and norepinephrine reuptake inhibitors (SNRIs) such as venlafaxine and duloxetine; Specific serotonergic/noradrenergic medications such as mirtazapine; Tricyclic antidepressants such as amitriptyline, protriptyline, doxepine, desipramine, imipramine, nortriptyline, trimipramine and amitriptyline/chlordiazepoxid; etc. The foregoing may be used alone or in combination with one another. Additional examples of active compounds that can be used as analgesics in the methods of the present invention include, but are not limited to, those described in U.S. Pat. Nos. 7,375,106; 7,332,183; 7,030,162; 6,926,907; 6,586,458; 6,479,551; 6,451,857; 6,060,499; 5,942,530 and 5,872,145, the disclosures of which are incorporated by reference herein in their entirety.

Active Agents for Headache Treatment. Examples of headache medications that can be used in carrying out the combination methods of the present invention include, but are not limited to: CGRP antagonists in U.S. Pat. No. 8,044,043; CGRP antagonists in combination with one or more agents selected from the group consisting of COX-2 inhibitors (as described above), NSAIDs (as described above), acetaminophen, triptans, ergotamine and caffeine for the treatment of migraine; bicyclic anilide spirolactones in U.S. Pat. No. 8,003,792. Additional agents include: acetaminophen U.S. Pat. No. 8,022,095; a 5-HT1_{β}/1_{D} agonist, preferably sumatriptan, and a long-acting NSAID, (preferably naproxen) are disclosed for the treatment of migraine, other preferred long-acting NSAIDs include cyclooxygenase-2 inhibitors (COX-2 inhibitors) U.S. Pat. No. 8,022,095. Acetaminophen, propoxyphene, codeine, anti-depressants, MAO inhibitors, anti-epileptic drugs or barbiturates for the treatment of headaches are disclosed in U.S. Pat. No. 8,008,351; peptidic compounds in U.S. Pat. No. 8,008,351; and antagonists of the ER4 receptor in U.S. Pat. No. 8,013,159. Headache medicines include but are not limited to analgesics as discussed above. Lists of anti-depressants, anti-epileptic drugs and barbiturates can be found below.

Anti-Diabetic Agents. Examples of anti-diabetic agents that can be used in carrying out the combination methods of the present invention include, but are not limited to, insulin, Biguanides such as Metformin (Glucophage) Phenformin, and Buformin; Thiazolidinediones or “glitazones,” such as rosiglitazone, pioglitazone, and troglitazone; Sulfonylureas such as tolbutamide, acetohexamide, tolazamide, chlorpropamide, glipizide, glyburide, glimepiride, and gliclazide; Meglitinides such as repaglinide and nateglinide; Alpha-glucosidase inhibitors such as miglitol and acarbose; Incretins or increintin mimetics such as glucagon-like peptide-1 (GLP-1) and gastric inhibitory peptide; Glucagon-like peptide (GLP) agonists such as Exenatide, Liraglutide, and Taspoglutide; Dipeptidyl peptidase-4 (DPP-4) inhibitors such as vildagliptin, sitagliptin, saxagliptin, and linagliptin; etc. Additional examples include but are not limited to those described in U.S. Pat. Nos. 7,939,551 and 7,803,778, the disclosures of which are incorporated by reference herein in their entirety.

Anti-Epileptic Agents. Examples of anti-epileptic and/or anti-convulsant agents that can be used in carrying out the combination methods of the present invention include, but are not limited to: AMPA antagonists such as AMP-397, E-2007, NS-1209, talampanel, and the like;

benzodiazepines such as diazepam, lorazepam, clonazepam, clobazam, and the like;
barbiturates such as phenobarbital, amobarbital, methylphenobarbital, primidone, and the like;
valproates such as valproic acid, valproate semisodium, valpromide, and the like; GABA agents such as gabapentin, pregabalin, vigabatrin, losigamone, retigabine, rufinamide, SPD-421 (DP-VPA), T-2000, XP-13512, and the like; iminostilbenes such as carbamazepine, oxcarbazepine, and the like; hydantoins such as phenyloin sodium, mephenyloin, fosphenyloin sodium, and the like; NMDA antagonists such as harkoseramide, and the like; sodium channel blockers such as BIA-2093, CO-102862, lamotrigine, and the like; succinimides such as methsuximide, ethosuximide, and the like; and AEDS (anti-epileptic and/or anti-convulsant agents) such as acetazolamide, clomthiazole edisilate, zonisamide, felbamate, topiramate, tiagabine, levetiracetam, briveracetam, GSK-362115, GSK-406725, ICA-69673, CBD cannabis derivative, isovaleramide (NPS-1776), carisbamate, safinamide, seletracetam, soretolide, stiripentol, valrocemide, (2S)-(−)-N-(6-chloro-2,3-dihydro-benzo[1,4]di-oxin-2-ylmethyl)-sulfamide, and the like (U.S. Pat. No. 7,897,636). In addition, the following classes of compounds may also be used: GABA prodrugs of gabapentin and pregabalin U.S. Pat. No. 8,048,917; calcium channel antagonists U.S. Pat. No. 8,034,954; sodium channel inhibitors including substituted benzenesulfonamides U.S. Pat. No. 8,063,080; substituted tetrahydropyrrolopyrazines U.S. Pat. No. 8,017,772; substituted isoquinolines U.S. Pat. No. 8,017,625; sulfonyl hydrazine derivatives U.S. Pat. No. 8,017,628; antiglycolytic compounds such as 2-deoxy-D-glucose U.S. Pat. No. 7,795,227; agmatine or agmatine analogs U.S. Pat. No. 7,816,407; benzoazolylpiperazines (U.S. Pat. No. 8,008,300); and pyrimido [4,5-D] azepine derivatives as 5-FIT_{2c}, agonists in U.S. Pat. No. 7,928,099. Lists of calcium channel antagonists can be found below.

Antidepressive Agents. Examples of anti-depressive agents that can be used in carrying out the combination methods of the present invention include, but are not limited to: SSRIs (selective serotonin reuptake inhibitors) that include, without limitation, the following: fluoxetine (e.g., fluoxetine hydrochloride, e.g., Prozac®), fluvoxamine (e.g., fluvoxamine maleate, e.g. Luvox®), paroxetine (e.g., paroxetine hydrochloride, e.g., Paxil®), sertraline (e.g., sertraline hydrochloride, e.g., Zoloft®), citalopram (e.g., citalopram hydrobromide, e.g., Celexa®), duloxetine (e.g., duloxetine hydrochloride), and venlafaxine (e.g., venlafaxine hydrochloride, e.g., Effexor®). Further SSRIs include those disclosed in U.S. Pat. No. 6,162,805 (U.S. Pat. No. 6,878,732). An antidepressant agent may be selected from the group: norepinephrine reuptake inhibitors, selective serotonin reuptake inhibitors, monoamine oxidase inhibitors, reversible monoamine oxidase inhibitors, serotonin and noradrenaline reuptake inhibitors, corticotropin releasing factor (CRF) antagonists, a-adrenoreceptor antagonists and atypical antidepressants, as a combined preparation for simultaneous, separate or sequential use in the treatment or prevention of depression and/or anxiety U.S. Pat. No. 6,117,855. Additional classes of agents include the tricyclic antidepressants such as amitriptyline, imipramine, doxepin, maprotiline, protriptyline, nortriptyline, desimipramine, clomipramine, trimipramine U.S. Pat. No. 6,127,385; tetracyclics such as dibenzoxepinon and dibenzothiepino-pyridinol or pyrrotol derivatives U.S. Pat. No. 4,977,158; and atypical antidepressants such as nefazodone or buproprion (should be spelled as bupropion) U.S. Pat. No. 6,127,385. Further classes are represented by (+)-1-(3,4-Dichlorophenyl)-3-azabicyclo[3.1.0]hexane U.S. Pat. No. 6,372,919; N¹-propargylhydrazines, N²-proargylhydrazines and their analogs U.S. Pat. No. 6,060,516 and NK-1 receptor antagonists U.S. Pat. No. 6,114,315. NK-1 receptor antagonists include MK-869 and CP-122,721 U.S. Pat. No. 8,071,778. Benzoazolylpiperazines have been disclosed in U.S. Pat. No. 8,008,300; thienopyridones as 5HT receptor agonists and partial agonists in U.S. Pat. No. 7,982,040; spirocyclic heterocyclic derivatives in U.S. Pat. No. 8,071,611; and pyrimido [4,5-D] azepine derivatives are disclosed as 5-HT_{2c} agonists in U.S. Pat. No. 7,928,099. Useful anti-depressant agents include but are not limited to, amitriptyline, clomipramine, doxepine, imipramine, trimipramine, amoxapine, desipramine, maprotiline, nortriptyline, protripyline, fluoxetine, fluvoxamine, paroxetine, setraline, venlafaxine, bupropion, nefazodone, trazodone, pheuelzine, tranylcypromine and selegiline U.S. Pat. No. 6,372,919. Anti-depressants of current interest include zimeldine, bupropion and nomifensine U.S. Pat. No. 7,982,040. Antidepressants, such as, for example, agomelatine, amitriptyline, amoxapine, bupropion, citalopram, clomipramine desipramine, doxepin, duloxetine, escitalopram, fluvoxamine, fluoxetine, gepirone, imipramine, ipsapirone, isocarboxazid, maprotiline, mirtazepine, nortriptyline, nefazodone paroxetine, phenelzine, protriptyline, ramelteon, reboxetine, robalzotan, selegiline, sertraline, sibutramine, thionisoxetine, tranylcypromaine, trazodone, trimipramine, venlafaxine, and equivalents and pharmaceutically active isomer(s) and metabolite(s) thereof, (U.S. Pat. No. 8,063,215).

Antipsychotic Agents: Examples of antipsychotic agents that can be used in carrying out the combination methods of the present invention include, but are not limited to: amisulpride, aripirazole, asenapine, benzisoxidil, bifeprunox, carbamazepine, clozapine, chlorpromazine, debenzapines, dibenzapine, divalproex, droperidol, fluphenazine, haloperidol, iloperidone, loxapine, mesoridazine, molindone, olanzapine, paliperidone, perphenazine, phenothiazine, phenylbutylpiperidine, pimozide, prochlorperazine, quetiapine, risperidone, sertindole, sulpiride, suproclone, thioridazine, thiothixene, trifluoperazine, trimetozine, valproate, valproic acid, zotepine, ziprasidone, and equivalents and pharmaceutically active isomer(s) and metabolite(s) thereof (U.S. Pat. No. 8,063,215).

Anxiolytic Agents. Examples of anxiolytic agents that can be used in carrying out the combination methods of the present invention include, but are not limited to: benzodiazepines, such as alprazolam, chlordiazepoxide, clonazepam, clorazepate, diazepam, halazepam, lorazepam, oxazepam, and prazepam; non-benzodiazepine agents, such as buspirone; and tranquilizers such as barbiturates U.S. Pat. No. 6,372,919. Pyrimido[4,5-D] azepine derivatives as 5-HT2c agonists in U.S. Pat. No. 7,928,099. Anxiolytics, such as, for example, alnespirone, azapirones, benzodiazepines, and barbiturates, such as, for example, adinazolam, alprazolam, balezepam, bentazepam, bromazepam, brotizolam, buspirone, clonazepam, clorazepate, chlordiazepoxide, cyprazepam, diazepam, estazolam, fenobam, flunitrazepam, flurazepam, fosazepam, lorazepam, lormetazepam, meprobamate, midazolam, nitrazepam, oxazepam, prazepam, quazepam, reclazepam, suriclone, tracazolate, trepipam, temazepam, triazolam, uldazepam, zolazepam, and equivalents and pharmaceutically active isomer(s) and metabolite(s) thereof U.S. Pat. No. 8,063,215. Additional classes of anxiolytics include substituted tetrahydropyrrolopyrazines U.S. Pat. No. 8,017,772; NK-1 receptor antagonists U.S. Pat. No. 6,114,315; N¹-propargyihydrazines, N²-proargylhydrazines and their analogs U.S. Pat. No. 6,060,516; benzoazolylpiperazines in U.S. Pat. No. 8,008,300; and thienopyridones in U.S. Pat. No. 7,982,040 (as serotonin receptor modulators).

Active Agents for Treating Bipolar Disorder. Examples of drugs used for the treatment of bipolar disorder that can be used in carrying out the combination methods of the present invention include, but are not limited to: SSRIs in combination with antipsychotics such as fluoxetine plus olanzapine U.S. Pat. No. 8,071,778; spirocyclic heterocyclic derivatives in U.S. Pat. No. 8,071,611; 4-piperazin-1-yl-4-benzo[B]thiophenes for the treatment of bipolar I type disorder and bipolar II type disorder U.S. Pat. No. 8,071,600; 3,9-diazabicyclo[3,3,1]nonanes in U.S. Pat. No. 8,071,598; 7-cycloalkylaminoquinolines are reported as GSK-3 inhibitors in U.S. Pat. No. 8,071,591; 1,2-disubstituted heterocyclic compounds are disclosed as phosphodiesterase 10 inhibitors in U.S. Pat. No. 8,071,595; and pyridine-alkynyl compounds are disclosed in U.S. Pat. No. 8,058,292. Lists of SSRIs and antipsychotics can be found above.

Mood Stabilizer Active Agents. Examples of drugs used to stabilize mood that can be used in carrying out the combination methods of the present invention include, but are not limited to: carbamazepine, divalproex, gabapentin, lamotrigine, lithium, olanzapine, oxycarbazepine, quetiapine, valproate, valproic acid, verapamil, and equivalents and pharmaceutically active isomer(s) and metabolite(s) thereof (U.S. Pat. No. 8,063,215).

Anti-Insomnia (Including Sedative Hypnotic) Active Agents Examples of insomnia and sedative hypnotic agents that can be used in carrying out the combination methods of the present invention include, but are not limited to: agomelatine, allobarbital, alonimid, amobarbital, benzoctamine, butabarbital, capuride, chloral hydrate, clonazepam, chlorazepate, cloperidone, clorethate, dexclamol, estazolam, eszopiclone, ethchlorvynol, etomidate, flurazepam, glutethimide, halazepam, hydroxyzine, mecloqualone, melatonin, mephobarbital, methaqualone, midaflur, midazolam, nisobamate, pagoclone, pentobarbital, perlapine, phenobarbital, propofol, quazepam, ramelteon, roletamide, suproclone, temazepam, triazolam, triclofos, secobarbital, zaleplon, zolpidem, zopiclone and equivalents and pharmaceutically active isomer(s) and metabolite(s) thereof (U.S. Pat. No. 8,063,215).

Active Agents for Treating Stroke. Examples of agents useful for the treatment of stroke that can be used in carrying out the combination methods of the present invention include, but are not limited to: abciximab, activase, NXY-059, citicoline, crobenetine, desmoteplase, repinotan, traxoprodil, and equivalents and pharmaceutically active isomer(s) and metabolite(s) thereof (U.S. Pat. No. 8,063,215).

Active Agents for Treating Substance Abuse Disorders, Dependence and Withdrawal. Examples of agents used to treat substance abuse disorders, dependence and withdrawal that can be used in carrying out the combination methods of the present invention include, but are not limited to: nicotine replacement therapies (i.e., gum, patches, and nasal spray); nicotinergic receptor agonists, partial agonists, and antagonists, (e.g. varenicline); acomprosate, bupropion, clonidine, disulfuram, methadone, naloxone, naltrexone, and equivalents and pharmaceutically active isomer(s) and metabolite(s) thereof (U.S. Pat. No. 8,063,215).

Active Agents for Treating ADHD Examples of agents used for the treatment of AHDH that can be used in carrying out the combination methods of the present invention include, but are not limited to: amphetamine, methamphetamine, dextroamphetamine, atomoxetine, methylphenidate, dexmethylphenidate, modafinil, and equivalents and pharmaceutically active isomer(s) and metabolite(s) thereof (U.S. Pat. No. 8,063,215).

Active Agents for Treating Alzheimer's Disease. Examples of agents that can be used for the treatment of Alzheimer's that can be used in carrying out the combination methods of the present invention include, but are not limited to: donepezil, galantamine, memantine, rivastigmine, tacrine, and equivalent and pharmaceutically active isomer(s) and metabolite(s) thereof (U.S. Pat. No. 8,063,215).

Active Agents for Treating Parkinson's Disease and Extrapyramidal Symptoms. Examples of agents that can be used for the treatment of Parkinson's and agents for the treatment of extrapyramidal symptoms that can be used in carrying out the combination methods of the present invention include, but are not limited to: levodopa, carbidopa, amantadine, pramipexole, ropinirole, pergolide, cabergoline, apomorphine, bromocriptine, MAOB inhibitors (i.e. selegine and rasagiline), COMT inhibitors (i.e. entacapone and tolcapone), alpha-2 inhibitors, anticholinergics (i.e., benztropine, biperiden, orphenadrine, procyclidine, and trihexyphenidyl), dopamine reuptake inhibitors, NMDA antagonists, Nicotine agonists, Dopamine agonists, and inhibitors of neuronal nitric oxide synthase, and equivalents and pharmaceutically active isomer(s) and metabolite(s) thereof (U.S. Pat. No. 8,063,215).

Active Agents for Treating Neuropathic Pain. Examples of agents used for the treatment of neuropathic pain that can be used in carrying out the combination methods of the present invention include, but are not limited to: gabapentin, lidoderm, pregablin, and equivalents and pharmaceutically active isomer(s) and metabolite(s) thereof (U.S. Pat. No. 8,063,215).

Active Agents for Treating Nociceptive Pain. Examples of agents used for the treatment of nociceptive pain that can be used in carrying out the combination methods of the present invention include, but are not limited to: celecoxib, codeine, diclofenac, etoricoxib, fentanyl, hydrocodone, hydromorphone, levo-alpha-acetylmethadol, loxoprofen, lumiracoxib, meperidine, methadone, morphine, naproxen, oxycodone, paracetamol, propoxyphene, rofecoxib, sufentanyl, valdecoxib, and equivalents and pharmaceutically active isomer(s) and metabolite(s) thereof (U.S. Pat. No. 8,063,215).

Active Agents for Treating Obesity. Examples of agents used for the treatment of obesity that can be used in carrying out the combination methods of the present invention include, but are not limited: anti-obesity drugs that affect energy expenditure, glycolysis, gluconeogenesis, glucogenolysis, lipolysis, lipogenesis, fat absorption, fat storage, fat excretion, hunger and/or satiety and/or craving mechanisms, appetite/motivation, food intake, and G-I motility; very low calorie diets (VLCD); and low-calorie diets (LCD) (U.S. Pat. No. 8,063,215).

Active Agents for Treating Obesity Associated Disorders Examples of agents useful for the treatment of obesity associated disorders that can be used in carrying out the combination methods of the present invention include, but are not limited to: for example, biguanide drugs, insulin (synthetic insulin analogues) and oral antihyperglycemics (these are divided into prandial glucose regulators and alpha-glucosidase inhibitors), PPAR modulating agents, such as, for example, PPAR alpha and/or gamma agonists; sulfonylureas; cholesterol-lowering agents, such as, for example, inhibitors of HMG-CoA reductase (3-hydroxy-3-methylglutaryl coenzyme A reductase); an inhibitor of the ileal bile acid transport system (IBAT inhibitor); a bile acid binding resin; bile acid sequestering agent, such as, for example, colestipol, cholestyramine, or cholestagel; a CETP (cholesteryl ester transfer protein) inhibitor; a cholesterol absorption antagonist; a MTP (microsomal transfer protein) inhibitor; a nicotinic acid derivative, including slow release and combination products; a phytosterol compound; probucol; an anti-coagulant; an omega-3 fatty acid; an anti-obesity therapy, such as, for example, sibutramine, phentermine, orlistat, bupropion, ephedrine, and thyroxine; an antihypertensive, such as, for example, an angiotensin converting enzyme (ACE) inhibitor, an angiotensin II receptor antagonist, an adrenergic blocker, an alpha adrenergic blocker, a beta adrenergic blocker, a mixed alpha/beta adrenergic blocker, an adrenergic stimulant, calcium channel blocker, an AT-1 blocker, a saluretic, a diuretic, and a vasodilator; a melanin concentrating hormone (MCH) modulator; an NPY receptor modulator; an orexin receptor modulator; a phosphoinositide-dependent protein kinase (PDK) modulator; modulators of nuclear receptors, such as, for example, LXR, FXR, RXR, GR, ERRα, β, PPARα, β, γ and RORalpha; a monoamine transmission- modulating agent, such as, for example, a selective serotonin reuptake inhibitor (SSRI), a noradrenaline reuptake inhibitor (NARI), noradrenaline-serotonin reuptake inhibitor (SNRI), a monoamine oxidase inhibitor (MAOI), a tricyclic antidepressive agent (TCA), a noradrenergic and specific serotonergic antidepressant (NaSSA); a serotonin receptor modulator; a leptin/leptin receptor modulator; a ghrelin/ghrelin receptor modulator; a DPP-IV inhibitor; and equivalents and pharmaceutically active isomer(s), metabolite(s), and pharmaceutically acceptable salts, solvates, and prodrugs thereof (U.S. Pat. No. 8,063,215). Lists of anti-hypertensive agents and cardiovascular agents can be found below. Lists of SSRIs and antidepressants can be found above.

Anti-Hypertensive Agents Examples of anti-hypertensive agents that can be used in carrying out the combination methods of the present invention include, but are not limited to: vasodilators such as prostacyclin, epoprostenol, and sildenafil; endothelin receptor antagonists such as bosentan; calcium channel blockers such as amlodipine, diltiazem, and nifedipine; anticoagulants such as warfarin; and diuretics. Treatment of PH has also been carried out using oxygen therapy; and lung and/or heart transplantation U.S. Pat. No. 8,071,557. Carbonic anhydrase inhibitors are disclosed in U.S. Pat. No. 8,071,557 while urotensin II receptor antagonists for the treatment of hypertension are disclosed in U.S. Pat. No. 8,067,601. 1-[2-(4-benzyl-4-hydroxy-piperdin-1-yl)-ethyl]-3-(2-methyl-quinolin-4-yl)-urea salts (urotensin II receptor antagonists) may also be used in combination with one or more other therapeutically useful substances e.g. with α- and β-blockers like phentolamine, phenoxybenzamine, atenolol, propranolol, timolol, metoprolol, carteolol, carvedilol, etc.; with vasodilators like hydralazine, minoxidil, diazoxide, flosequinan, etc.; with calcium-antagonists like diltiazem, nicardipine, nimodipine, verapamil, nifedipine, etc.; with angiotensin converting enzyme-inhibitors like cilazapril, captopril, enalapril, lisinopril etc.; with potassium channel activators like pinacidil, chromakalim, etc.; with angiotensin receptor antagonists like losartan, valsartan, candesartan, irbesartan, eprosartan, telmisartan, and tasosartan, etc.; with diuretics like hydrochlorothiazide, chlorothiazide, acetolamide, bumetanide, furosemide, metolazone, chlortalidone, etc.; with sympatholytics like methyldopa, clonidine, guanabenz, reserpine, etc.; with endothelin receptor antagonists like bosentan, clazosentan, tezosentan, darusentan, atrasentan, enrasentan, or sitaxsentan, etc.; with anti-hyperlipidemic agents like lovastatin, pravastatin, fluvastatin, atorvastatin, cerivastatin, simvastatin, etc.; and other therapeutics which serve to treat high blood pressure, vascular disease or other disorders listed above U.S. Pat. No. 8,067,601. Antihypertensives such as, for example, an angiotensin converting enzyme (ACE) inhibitor, an angiotensin II receptor antagonist, an adrenergic blocker, an alpha adrenergic blocker, a beta adrenergic blocker, a mixed alpha/beta adrenergic blocker, an adrenergic stimulant, calcium channel blocker, an AT-1 blocker, a saluretic, a diuretic, and a vasodilator are disclosed in U.S. Pat. No. 8,063,215. Examples of the antihypertensive drugs include angiotensin converting enzyme inhibitors (such as captopril, alacepril, lisinopril, imidapril, quinapril, temocapril, delapril, benazepril, cilazapril, trandolapril, enalapril, ceronapril, fosinopril, imadapril, mobertpril, perindopril, ramipril, spirapril, and randolapril), angiotensin II antagonists (such as losartan, candesartan, valsartan, eprosartan, and irbesartan), calcium channel blocking drugs (such as aranidipine, efonidipine, nicardipine, bamidipine, benidipine, manidipine, cilnidipine, nisoldipine, nitrendipine, nifedipine, nilvadipine, felodipine, amlodipine, diltiazem, bepridil, clentiazem, phendilin, galopamil, mibefradil, prenylamine, semotiadil, terodiline, verapamil, cilnidipine, elgodipine, isradipine, lacidipine, lercanidipine, nimodipine, cinnarizine, flunarizine, lidoflazine, lomerizine, bencyclane, etafenone, and perhexyline), β-adrenaline receptor blocking drugs (propranolol, pindolol, indenolol, carteolol, bunitrolol, atenolol, acebutolol, metoprolol, timolol, nipradilol, penbutolol, nadolol, tilisolol, carvedilol, bisoprolol, betaxolol, celiprolol, bopindolol, bevantolol, labetalol, alprenolol, amosulalol, arotinolol, befunolol, bucumolol, bufeiolol, buferalol, buprandolol, butylidine, butofilolol, carazolol, cetamolol, cloranolol, dilevalol, epanolol, levobunolol, mepindolol, metipranolol, moprolol, nadoxolol, nevibolol, oxprenolol, practol, pronetalol, sotalol, sufinalol, talindolol, tertalol, toliprolol, xybenolol, and esmolol), α-receptor blocking drugs (such as amosulalol, prazosin, terazosin, doxazosin, bunazosin, urapidil, phentolamine, arotinolol, dapiprazole, fenspiride, indoramin, labetalol, naftopidil, nicergoline, tamsulosin, tolazoline, trimazosin, and yohimbine), sympathetic nerve inhibitors (such as clonidine, guanfacine, guanabenz, methyldopa, and reserpine), hydralazine, todralazine, budralazine, and cadralazine U.S. Pat. No. 8,044,198.

Cardiovascular Agents Examples of cardiovascular agents that can be used in carrying out the combination methods of the present invention include, but are not limited to: vasodilators, for example, hydralazine; angiotensin converting enzyme inhibitors, for example, captopril; anti-anginal agents, for example, isosorbide nitrate, glyceryl trinitrate and pentaerythritol tetranitrate; anti-arrhythmic agents, for example, quinidine, procainaltide and lignocaine; cardioglycosides, for example, digoxin and digitoxin; calcium antagonists, for example, verapamil and nifedipine; diuretics, such as thiazides and related compounds, for example, bendrofluazide, chlorothiazide, chlorothalidone, hydrochlorothiazide and other diuretics, for example, fursemide and triamterene, and sedatives, for example, nitrazepam, flurazepam and diazepam. Other exemplary cardiovascular agents include, for example, a cyclooxygenase inhibitor such as aspirin or indomethacin, a platelet aggregation inhibitor such as clopidogrel, ticlopidene or aspirin, fibrinogen antagonists or a diuretic such as chlorothiazide, hydrochlorothiazide, flumethiazide, hydroflumethiazide, bendroflumethiazide, methylchiorthiazide, trichloromethiazide, polythiazide or benzthiazide as well as ethacrynic acid tricrynafen, chlorthalidone, furosemide, musolimine, bumetanide, triamterene, amiloride and spironolactone and salts of such compounds, angiotensin converting enzyme inhibitors such as captopril, zofenopril, fosinopril, enalapril, ceranopril, cilazopril, delapril, pentopril, quinapril, ramipril, lisinopril, and salts of such compounds, angiotensin II antagonists such as losartan, irbesartan or valsartan, thrombolytic agents such as tissue plasminogen activator (tPA), recombinant tPA, streptokinase, urokinase, prourokinase, and anisoylated plasminogen streptokinase activator complex (APSAC, Eminase, Beecham Laboratories), or animal salivary gland plasminogen activators, calcium channel blocking agents such as verapamil, nifedipine or diltiazem, thromboxane receptor antagonists such as ifetroban, prostacyclin mimetics, or phosphodiesterase inhibitors. Yet other exemplary cardiovascular agents include, for example, vasodilators, e.g., bencyclane, cinnarizine, citicoline, cyclandelate, cyclonicate, ebumamonine, phenoxezyl, flunarizine, ibudilast, ifenprodil, lomerizine, naphlole, nikamate, nosergoline, nimodipine, papaverine, pentifylline, nofedoline, vincamin, vinpocetine, vichizyl, pentoxifylline, prostacyclin derivatives (such as prostaglandin E1 and prostaglandin I2), an endothelin receptor blocking drug (such as bosentan), diltiazem, nicorandil, and nitroglycerin U.S. Pat. No. 8,044,198.

Anti-Arrhythmia Agents Examples of anti-arrhythmia agents that can be used in carrying out the combination methods of the present invention include, but are not limited to: four main groups according to their mechanism of action: type I, sodium channel blockade; type II, beta-adrenergic blockade; type III, repolarization prolongation; and type IV, calcium channel blockade. Type I anti-arrhythmic agents include lidocaine, moricizine, mexiletine, tocamide, procainamide, encamide, flecanide, tocamide, phenyloin, propafenone, quinidine, disopyramide, and flecamide. Type II anti-arrhythmic agents include propranolol and esmolol. Type III includes agents that act by prolonging the duration of the action potential, such as amiodarone, artilide, bretylium, clofilium, isobutilide, sotalol, azimilide, dofetilide, dronedarone, ersentilide, ibutilide, tedisamil, and trecetilide. Type IV anti-arrhythmic agents include verapamil, diltaizem, digitalis, adenosine, nickel chloride, and magnesium ions U.S. Pat. No. 8,044,198. Lists of beta-adrenergic blockers and calcium blockers can be found above.

Antianginal Agents Examples of antianginal agents that can be used in carrying out the combination methods of the present invention include, but are not limited to: nitrate drugs (such as amyl nitrite, nitroglycerin, and isosorbide), O-adrenaline receptor blocking drugs (such as propranolol, pindolol, indenolol, carteolol, bunitrolol, atenolol, acebutolol, metoprolol, timolol, nipradilol, penbutolol, nadolol, tilisolol, carvedilol, bisoprolol, betaxolol, celiprolol, bopindolol, bevantolol, labetalol, alprenolol, amosulalol, arotinolol, befunolol, bucumolol, bufetolol, buferalol, buprandolol, butylidine, butofilolol, carazolol, cetamolol, cloranolol, dilevalol, epanolol, levobunolol, mepindolol, metipranolol, moprolol, nadoxolol, nevibolol, oxprenolol, practol, pronetalol, sotalol, sufinalol, talindolol, tertalol, toliprolol, and xybenolol), calcium channel blocking drugs (such as aranidipine, efonidipine, nicardipine, bamidipine, benidipine, manidipine, cilnidipine, nisoldipine, nitrendipine, nifedipine, nilvadipine, felodipine, amlodipine, diltiazem, bepridil, clentiazem, phendiline, galopamil, mibefradil, prenylamine, semotiadil, terodiline, verapamil, cilnidipine, elgodipine, isradipine, lacidipine, lercanidipine, nimodipine, cinnarizine, flunarizine, lidoflazine, lomerizine, bencyclane, etafenone, and perhexyline) trimetazidine, dipyridamole, etafenone, dilazep, trapidil, nicorandil, enoxaparin, and aspirin U.S. Pat. No. 8,044,198.

Active Agents Used for Treating Traumatic Brain Injury, Neuroprotective Agents, Cerebral Protecting Agents. Examples of agents used as a result of traumatic brain injury, neuroprotective agents and/or cerebral protecting agents that can be used in carrying out the combination methods of the present invention include, but are not limited to: anesthetics such as phenol derivatives disclosed in U.S. Pat. No. 8,071,818; neuroprotective agents such as Gly-Pro-Glu (GPE) and analogs, cyclic Pro-Gly (“cPG”), diketopiperazine analogs of thyrotropin-releasing hormone (TRH), and novel diketopiperazines (U.S. Pat. No. 8,067,425) and disclosures of which are incorporated by reference herein in their entirety. In U.S. Pat. No. 8,063,215, cyclopropyl amides are targeted at the histamine H3 receptor as potential treatments for traumatic brain injury. In U.S. Pat. No. 8,071,602, SA 4503, diamines, piperazine derivatives, homopiperazines are incorporated by reference. In addition, 1,4-piperidine and piperazine derivatives with high affinity for sigma-1 receptors are disclosed (U.S. Pat. No. 8,071,602). In U.S. Pat. No. 8,067,425, novel diketopiperazines structurally related to cPG are disclosed. Additional neuroprotective agents, include for example, growth factors and associated derivatives (insulin-like growth factor-I [IGF-I], insulin-like growth factor-Il [IGF-II], transforming growth factor-#1, activin, growth hormone, nerve growth factor, growth hormone binding protein, IGF-binding proteins [especially IGFBP-3], basic fibroblast growth factor, acidic fibroblast growth factor, the hst/Kfgk gene product, FGF-3, FGF-4, FGF-6, keratinocyte growth factor, androgen-induced growth factor. Additional members of the FGF family include, for example, int-2, fibroblast growth factor homologous factor-1 (FHF-1), FHF-2, FHF-3 and FHF-4, karatinocyte growth factor 2, glial-activating factor FGF-10 and FGF-16, ciliary neurotrophic factor, brain derived growth factor, neurotrophin 3, neurotrophin 4, bone morphogenetic protein 2 [BMP-2], glial-cell line derived neurotrophic factor, activity-dependant neurotrophic factor, cytokine leukaemia inhibiting factor, oncostatin M, interleukin α-, β-, γ-, or consensus interferon, and TNF-α. Other forms of neuroprotective therapeutic agents include, for example, clomethiazole; kynurenic acid, Semax, tacrolimus, L-threo-1-phenyl-2-decanoylamino-3-morpholino-1-pro-panol, andrenocorticotropin-(4-9) analogue [ORG 2766] and dizolcipine [MK-801], selegiline; glutamate antagonists such as, NP51506, GV1505260, MK-801, GV150526; AMPA antagonists such as 2,3-dihydroxy-6-nitro-7-sulfamoylbenzo(f)quinoxaline (NBQX), LY303070 and LY300164; anti-inflammatory agents directed against the addressin MAd-CAM-1 and/or its integrin α4 receptors (α4β1 and α4β7), such as anti-MAdCAM-1 mAb MECA-367 (ATCC accession no. HB-9478) U.S. Pat. No. 8,967,425. Examples of cerebral protecting drugs include radical scavengers (such as edaravone, vitamin E, and vitamin C), glutamate antagonists, AMPA antagonists, kainate antagonists, NMDA antagonists, GABA agonists, growth factors, opioid antagonists, phosphatidylcholine precursors, serotonin agonists, Na⁺/Ca⁺² channel inhibitory drugs, and K⁺ channel opening drugs U.S. Pat. No. 8,044,198.

Active Agents for Treating Premenstrual Syndrome and Premenstrual Dysphoric Disorder. Examples of agents used to treat prementrual syndrome and/or premenstrual dysphoric disorder that can be used in carrying out the combination methods of the present invention include, but are not limited to: Zoloft U.S. Pat. No. 8,012,958; tachykinin and serotonin modulators U.S. Pat. No. 8,071,778 and its disclosures of which are incorporated by reference herein in their entirety; progestagens U.S. Pat. No. 8,063,037 and its disclosures of which are incorporated by reference herein in their entirety; controlled release compositions comprising a LH-RH derivative U.S. Pat. No. 8,067,030; selective androgen modulators that may be employed alone or in combination with other therapeutic agents. By way of non-limiting example, the compounds of this invention can be used in combination with anti-lipidemics (statins, fibrates, omega-3 oils, niacinates and the like), bone anti-resorptives (bisphosphonates, estrogens, selective estrogen receptor modulators (SERMs), calcitonin, and the like), bone anabolic agents (PTH and fragments e.g teriparatide, PTHRP and analogues e.g. Ba058), anti-diabetics (e.g. insulin sensitizers, glucose absorption and synthesis inhibitors (e.g. metformin)), anti-anxiety agents, antidepressants, anti-obesity agents, contraceptive agents, anti-cancer agents, PPARy agonists (e.g. pioglitazone), and the like U.S. Pat. No. 8,067,448. Additional agents for the treatment of prementrual syndrome and/or premenstrual dysphoric disorder include: diuretics including bumetanide, ethacrynic acid, furosemide, muzolimine, spironolactone, torsemide, triamterene, tripamide HG 9928, and HG 9719; Ginko extracts U.S. Pat. No. 7,923,045; sirtuin modulating compounds U.S. Pat. No. 8,044,198. Diuretics also include compounds such as chlorothiazide, hydrochlorothiazide, flumethiazide, hydroflumethiazide, bendroflumethiazide, methylchiorthiazide, trichloromethiazide, polythiazide or benzthiazide as well as ethacrynic acid tricrynafen, chlorthalidone, furosemide, musolimine, bumetanide, triamterene, amiloride and spironolactone and salts of such compounds; thiazide diuretics (such as hydrochlorothiazide, methyclothiazide, trichlormethiazide, benzylhydrochlorothiazide, and penflutizide), loop diuretics (such as furosemide, etacrynic acid, bumetanide, piretanide, azosemide, and torasemide), K⁺ sparing diuretics (spironolactone, triamterene, and potassium canrenoate), osmotic diuretics (such as isosorbide, D-mannitol, and glycerin), nonthiazide diuretics (such as meticrane, tripamide, chlorthalidone, and mefruside), and acetazolamide U.S. Pat. No. 8,044,198. Additional agents include α_{1D} adrenergic receptor antagonists U.S. Pat. No. 7,985,863; supplements and DL-phenylalanine U.S. Pat. No. 7,871,609. Analgesics, anti-anxiety (anxiolytics), anti-diabetic agents, anti-obesity and antidepressants as described above.

The present invention is explained in greater detail in the following non-limiting Examples.

### EXAMPLE

We sought to identify a more practical intervention to improve adherence that would mimic the effects of frequent office visits. Since adolescents are quite skilled in the use of technology and utilize the internet on a regular basis, we assessed whether an internet-based communication could improve teen's adherence to topical acne therapy.

Methods: This was an investigator-blinded, randomized, prospective study testing the impact of an internet-based survey and contest on treatment adherence in teenagers with acne vulgaris. Twenty male and female subjects, aged 13 through 18, with mild to moderate acne were provided with topical benzoyl peroxide 5% gel and instructed to apply to the face daily for 12 weeks. All subjects were scheduled return visits at weeks 6 and 12. The study sample size was based on available resources and the need to obtain pilot data for power analyses of larger intervention trials.

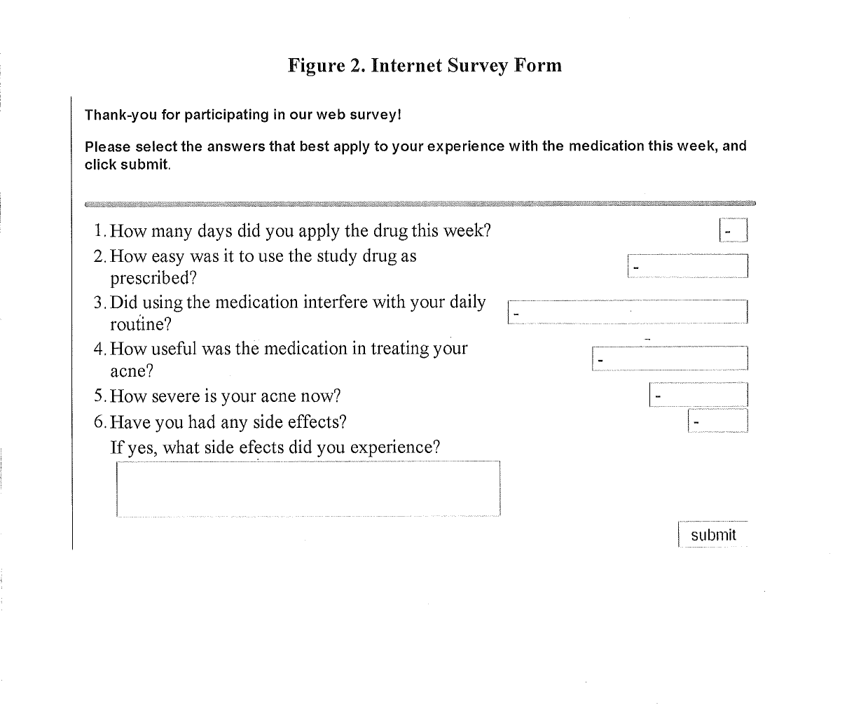

At the baseline visit, subjects were randomized 1:1 to a control group or to an internet survey group. Subjects in the control group received no further intervention beyond the aforementioned instructions and return visits. Subjects in the internet survey group were sent a weekly email that contained a link to a survey (FIG. 2) assessing their acne severity and treatment. In the survey, the following questions were asked (also listed are the potential answer choices):
1. How many days did you apply the drug this week? (1-7);
2. How easy was it to use the study drug as prescribed? (Very Easy, OK, Inconvenient, Very Difficult);
3. Did using the medication interfere with your daily routine? (Yes, No), If Yes, how much? (Just another thing to do, Completely interrupted my day);
4. How useful was the medication in treating your acne? (Acne is clear, No Change, Acne much worse);
5. How severe is your acne now? (Clear, Mild, Moderate, Severe);
6. Have you had any side effects? (Yes, No), If yes, what side effect did you experience?

If subjects in the internet group completed at least 5 surveys during a 6 week period, they received a $5 gift card to Amazon.com. Additionally, each completed survey provided the subject with an additional chance to win an iPod nano at the end of the study. The winner was drawn at random.

Adherence to treatment was monitored objectively via the Medication Events Monitoring System (MEMS®, AARDEX Corporation, Fremont, Calif.).(10) These devices recorded the date and time when the medication containers were opened. Subjects were not informed of the MEMS monitoring until the last study visit. Clinical evaluators were blinded to the adherence data.

Subjects' acne severity was also evaluated at baseline, week 6, and week 12 (end of study). Acne disease severity was measured using the Acne Global Assessment (AGA) as well as inflammatory and noninflammatory lesion counts at each visit.(11)

Statistical Analysis: Analyses were performed using the SAS 9.1 software (SAS Institute, Cary, N.C.). Kruskal-Wallis test was used for comparing adherence between the groups. MEMS® cap overall adherence was defined as the proportion of days during the 12-week active treatment phase of the trial that the cap recorded at least 1 event or opening of the medication. Simple linear regression models were generated to assess significance in changes in adherence over time. Wilcoxon sign rank tests were used to compare the number of inflammatory and non-inflammatory acne lesions observed at baseline with the number observed at each return visit. Kruskal-Wallis test was also used when comparing disease improvement between the groups.

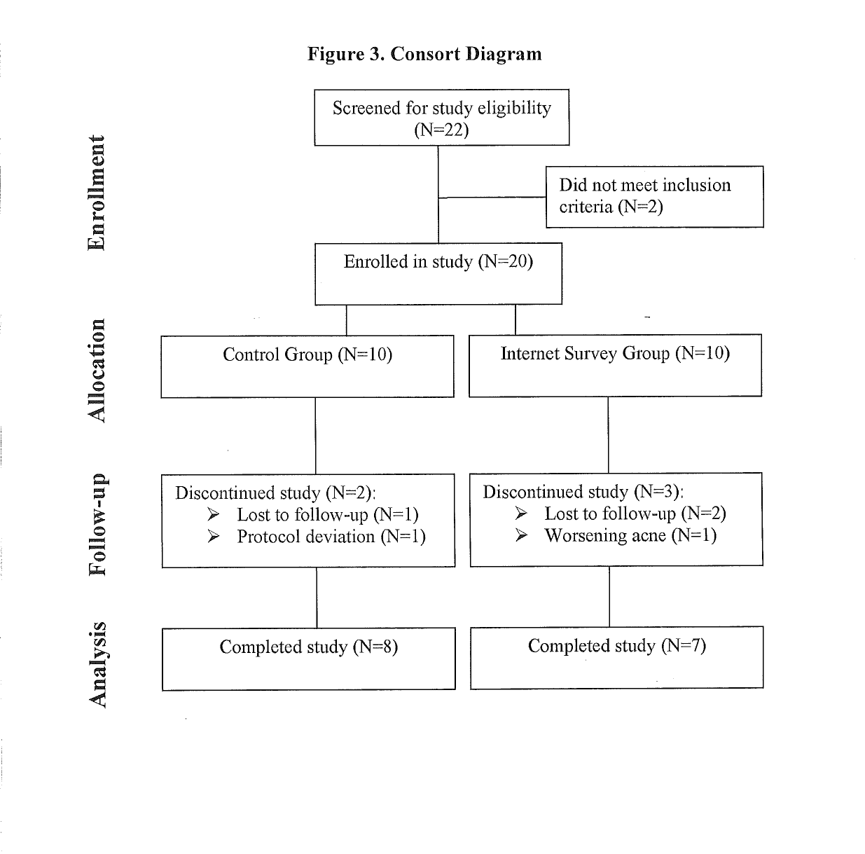

Results: Of the 20 subjects enrolled in this study, 12 were female, 8 were white, 9 were black, 1 was Hispanic, and 2 “Other”. Ages ranged from 13 to 18 years, with a mean age of 15. Ten subjects were assigned to each group (FIG. 3). Eight subjects from the control group and 7 from the Internet Survey group completed the 12 week study. Treatment was well tolerated, and there were no serious adverse events reported. All adverse events were mild and not thought to be related to treatment. One subject from the internet group withdrew from the study due to worsening acne.

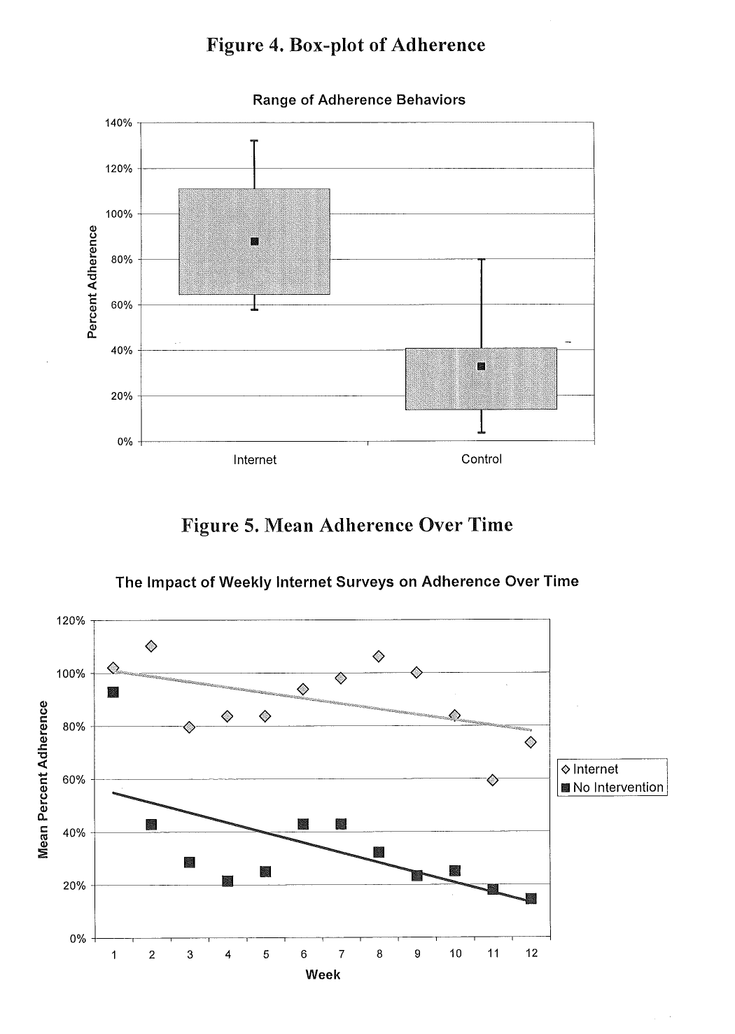

Overall adherence ranged from 58% to 132% for the Internet survey group, and ranged from 4% to 80% for the Control group (FIG. 4). Median and mean adherence in the Internet group was 74% and 89%, respectively. Median and mean adherence in the control group was 32% and 33%, respectively. This difference in overall adherence between groups was statistically significant (P<0.01). This is a dramatic increase in compliance for the Internet survey group, especially since the potential to win the $5 Amazon gift card and/or the iPod nano was tied to the completion of the survey(s) and not to the actual topical benzoyl peroxide 5% gel treatment.

Furthermore, in the control group, mean adherence dropped from 93% at week 1 to 14% by week 12 (FIG. 5). This drop over time was statistically significant (P=0.02). There was no statistically significant change in adherence over time for the internet group (P=0.10), with a mean adherence of 102% at week 1 versus 73% at week 12. The median number of drug-free days, when no drug was applied in a 24-hour period as measured by MEMS, was 30 in the internet versus 66 in the control group (P<0.01). Within the Internet Survey group, there was no significant difference between patient-reported adherence via the internet survey and adherence measured via MEMS (P=0.11).

Baseline severity was similar between the 2 groups (Kruskal Wallis test for difference in AGA and lesion counts between groups, P>0.1). Both groups had significant improvements from baseline to week 6 in non-inflammatory lesion counts. There was a direct correlation between measured adherence (mean MEMS counts) during the first 6 weeks and the percent improvement in noninflammatory lesions observed at week 6 (linear regression, P<0.05). While the Internet group demonstrated greater mean percent reduction of noninflammatory and total lesion counts (44% vs. 11% and 36% vs. 13%, respectively), this difference did not reach statistical significance.

Discussion: Non-adherence to medication regimens, particularly to topical therapies, is a pervasive problem, (12-14) and physicians need interventions to improve adherence that are cost-effective, practical, and easily implemented in routine clinical practice. As demonstrated in this pilot study, an automated internet-based system of communication may provide just that. Adolescents are savvy users of the internet and other newer technologies, and may respond well to such interaction. Communication via the internet may alleviate discomfort associated with an office visit and improve subjects' sense of control over their treatment. This intervention is expected to be applicable to patients of any age and with any condition, permitting a feasible means of encouraging better adherence to treatment or other recommended behaviors.

Since other forms of electronic “reminders” have not been very effective at increasing adherence in teens with acne, it is likely that our internet-based survey acted in ways different from a simple reminder. Secondary gain may have contributed to subjects' motivation to complete the survey, but the study did not pay subjects to use their medication.(15) The financial incentive was valued at $1 for each time the survey was completed, in addition to an entry to win an iPod at study completion. This secondary gain, which was given independent of whether the subjects used their medication or not, may have been enough to make the subjects engage in the Internet interaction on a weekly basis. Without wishing to be limited to any particular theory of the invention, we believe the survey component of the intervention may have acted like a physician office visit, assessing how the patient's felt about their acne and their treatment. The increased adherence observed with this “virtual office visit” may be driven by the same factors that drive “white-coat compliance.”(9;10)

Adherence research in dermatology is at an early stage. Analysis of the frequency of non-adherence, and the efficacy of new techniques to enhance adherence, along with focused development of ‘forgiving pharmaceuticals’ is essential to continued growth in the field of dermatology.(16) The present invention accordingly provides a means of enhancing adherence, in both dermatology and in other areas of pharmacological treatment.

### EXAMPLE 2

### Modification to Include Photo Survey

Patients often do not use their medications as directed, adversely affecting their treatment outcomes. In some cases patients stop using the prescribed medication due to irritation or some other expected effect of the drug. Several drug classes cause considerable skin irritation, including therapies used to treat actinic keratoses and superficial skin cancers, topical retinoids used in the treatment of acne, and vitamin D preparations used in the treatment of psoriasis. These medications are often well tolerated in clinical trials in which patients are seen at frequent intervals. In that setting, people don't worry so much about the irritation because they will be seeing the doctor before long in one of the study visits at which they are told the irritation is nothing to worry about. Patients may feel that the reaction looks or feels bad, but since they will be seeing the doctor in a day or a few days, they don't worry too much about it.

In standard clinical practice, however, patients using these medications may not anticipate the degree of irritation they experience, and may stop the medication prematurely, losing out on the benefit of the treatment. They may be terrified that the reaction is unanticipated or that it may worsen horribly. They usually do not have a return visit scheduled for some considerable period of time and may worry that there condition will become much worse before the next visit. They may need to call the clinic for advice or even come for unscheduled office visit to clarify that their experience is simply an expected effect of the prescribed medication. Callbacks and unscheduled office visits consume precious healthcare resources and are burdensome to a physician's already busy schedule.

Electronic communications offer the opportunity to communicate to patients a range of effects of a medication, with the use of visual aids, in order to reassure patients that what they are experiencing is an expected part of the treatment course. An electronic interaction—completing an electronic survey—that enhances patients' adherence to treatment is described above. The electronic survey is superior to a patient handout or information sheet as patients receive an email link to complete the survey on a regular basis, which serves as a form of interaction with the healthcare provider.

As a complement to/component of the survey, we have developed another aspect of the survey that specifically addresses the problem of irritation causing patients to stop the use of their medication. This aspect is a means to reassure patients of the expected irritation that accompanies many dermatologic medications, thereby improving their use of the prescribed medication.

The feature is an internet-based survey consisting of a series of photos in the brief questionnaire in which patients rate the degree of irritation they are experiencing by clicking on a button beneath a series of graphical depictions (e.g., drawings or photographs) representing a range of medication irritation, from mild to very severe. The photos can include one photo that shows a severity of irritation beyond what patients commonly experience but which is still a normal reaction. The photographs can be complemented by information that will inform patients that these severities of irritation are normal events, nothing to worry about, that resolve with time. This electronic “handholding” interaction will improve how well patients use their medications, and also decrease callbacks and unscheduled office visits for expected medication irritation. This is a low cost, highly feasible, very general way to improve patients' use of their medication. The survey can be automated and is done completely over the Internet.

Patients are prompted to complete a brief survey on their use of medication with a weekly email message containing a link to the survey:

“Thank-you for participating in our study! Please click the link below to complete the short survey: https://. . . link.hmtl”.

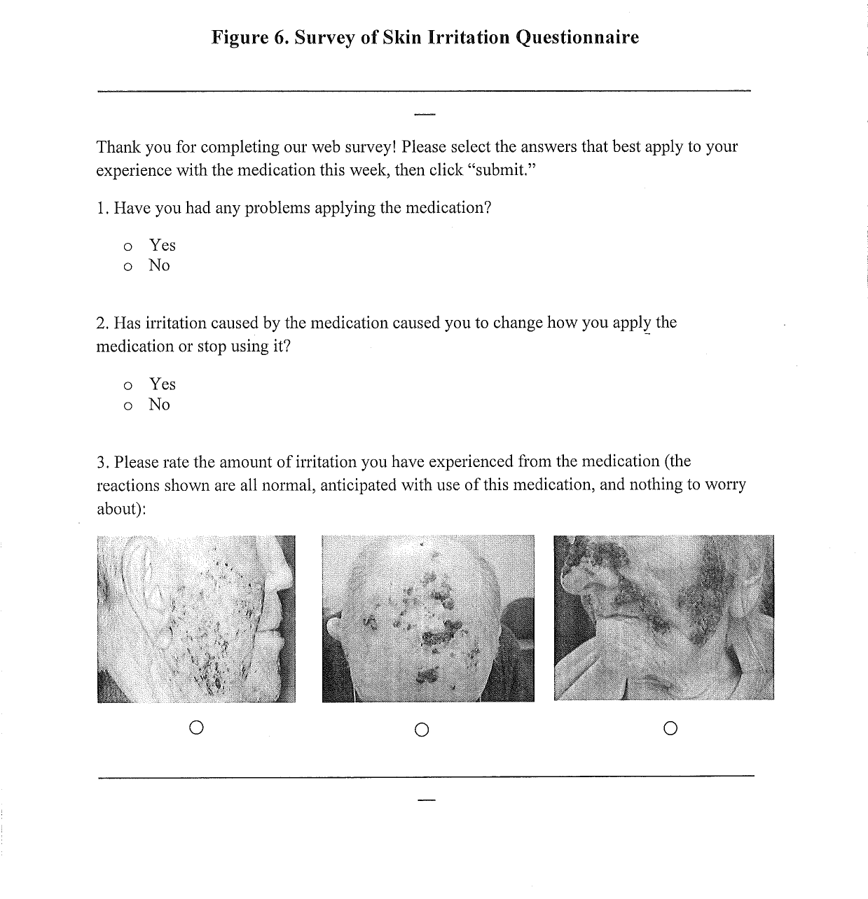

An example of the survey display is given in FIG. 6 below:

### REFERENCES

(1) Lee D J, Van Dyke G S, Kim J. Update on pathogenesis and treatment of acne. Curr Opin Pediatr 2003; 15 (4):405-410.
(2) Kellett S C, Gawkrodger D J. The psychological and emotional impact of acne and the effect of treatment with isotretinoin. Br J Dermatol 1999; 140 (2):273-282.
(3) Eisen S A et al. The effect of medication compliance on the control of hypertension. J Gen Intern Med 1987; 2 (5):298-305.
(4) Paterson D L, Swindells S, Mohr J et al. Adherence to protease inhibitor therapy and outcomes in patients with HIV infection Ann Intern Med 2000; 133 (1):21-30.
(5) Piacquadio D, Kligman A. The critical role of the vehicle to therapeutic efficacy and patient compliance. J Am Acad Dermatol 1998; 39 (2 Pt 3):S67-S73.
(6) Witkowski J A. Compliance: the dermatologic patient. Int J Dermatol 1988; 27 (9):608-611.
(7) Giuffrida A, Torgerson D. T. Should we pay the patient? Review of financial incentives to enhance patient compliance. BMJ 1997; 315 (7110):703-707.
(8) Smith S R, et al., A medication self-management program to improve adherence to HIV therapy regimens. Patient Educ Couns 2003; 50 (2):187-199.
(9) Feinstein A R. On white-coat effects and the electronic monitoring of compliance. Arch Intern Med 1990; 150 (7):1377-1378.
(10) Feldman S R, et al., Adherence to topical therapy increases around the time of office visits. J Am Acad Dermatol 2007; 57 (1):81-83.
(11) Allen B S, Smith J G, Jr. Various parameters for grading acne vulgaris. Arch Dermatol 1982; 118 (1):23-25.
(12) Krejci-Manwaring J, Tusa M G, Carroll C et al. Stealth monitoring of adherence to topical medication: adherence is very poor in children with atopic dermatitis. J Am Acad Dermatol 2007; 56 (2):211-216.
(13) Richards H L, Fortune D G, O'Sullivan T M, Main C J, Griffiths C E. Patients with psoriasis and their compliance with medication. J Am Acad Dermatol 1999; 41 (4): 581-583.
(14) Krejci-Manwaring J, McCarty M A, Camacho F et al. Adherence with topical treatment is poor compared with adherence with oral agents: implications for effective clinical use of topical agents. J Am Acad Dermatol 2006; 54 (5 Suppl):S235-S236.
(15) Yentzer B A, Gosnell A L, Clark A R et al. A randomized controlled pilot study of strategies to increase adherence in teenagers with Acne vulgaris. J Am Acad Dermatol 2010.
(16) Koehler A M, Maibach H I. Electronic monitoring in medication adherence measurement. Implications for dermatology. Am J Clin Dermatol 2001; 2 (1):7-12.

The foregoing is illustrative of the present invention, and is not to be construed as limiting thereof The invention is defined by the following claims, with equivalents of the claims to be included therein.

1. A method for improving subject adherence to a regimen, comprising:
(a) assigning at least one subject to a survey group, wherein each subject is to participate in a regimen on a regular regimen schedule; then
(b) transmitting a survey prompt to each of said subjects on a regular survey schedule so that said subject is prompted to complete a survey regarding their use of and/or the outcome of the regimen;
(c) receiving a survey response from those of said subjects who respond to said survey prompt; and
(d) performing step (b) to (c) on one or more occasions, so that subject adherence to said regimen is enhanced.

2. The method of claim 1, wherein adherence to said regimen by said subjects receiving said survey prompt is at least 20 percent greater as compared to control subjects assigned the same regimen who do not receive said survey prompt.

3. The method according to claim 1, wherein said regimen is a treatment regimen for a condition with which said subject is afflicted.

4. The method according to claim 3, wherein said treatment regimen is an exercise regimen, drug regimen, or combination thereof.

5. The method of claim 4, wherein said condition is a dermatological condition and said treatment is a topical treatment.

6. The method of claim 1, wherein said regimen is carried out once or twice daily for at least 4 weeks.

7. The method of claim 1, wherein said survey schedule is once or twice weekly for 4 to 8 weeks.

8. The method of claim 1, wherein said step of transmitting a survey prompt is carried out by automated transmission of an internet or telephone message.

9. The method of claim 1, wherein said step of receiving a survey response is carried out by automated processing of an internet or telephone survey.

10. The method of claim 1, wherein said assigning step further comprises:
alerting each of said subjects of the availability of said reward.

11. The method of claim 1, further comprising:
(e) determining from said survey responses those subjects who have completed said internet-based survey in at least a predetermined number of occasions; and then
(f) notifying those subjects who have completed said survey on at least said predetermined number of occasions of their receipt of a first reward.

12. The method of claim 11, wherein said predetermined number of occasions is at least ¾ of the total number of surveys in said survey schedule.

13. The method of claim 11, wherein:
said assigning step further comprises alerting each of said subjects of a chance of receiving a second reward, and
said notifying step further comprises notifying a subset of those subjects receiving said first reward of their receipt of said second reward.

14. The method of claim 11, wherein the reward is not based on the subject participating in a regimen.

15. The method of claim 1, wherein said at least one subject comprises a plurality of subjects undergoing treatment by a common health care provider.

16. The method of claim 1, wherein said survey includes at least one question concerning a side-effect, said question optionally having associated therewith a graphical depiction of said side-effect, said graphical depiction optionally having associated therewith a statement concerning the severity of the side-effect in said graphical depiction.

17. The method of claim 16, wherein said side-effect is skin irritation.

18. A system for improving subject adherence to a regimen, comprising:
(a) means for assigning at least one subject to a survey group, wherein each subject is to participate in a regimen on a regular regimen schedule;
(b) means for transmitting a survey prompt to each of said subjects on a regular survey schedule so that said subject is prompted to complete a survey regarding their use of and/or the outcome of the regimen;
(c) means for receiving a survey response from those of said subjects who respond to said survey prompt; and
(d) means for performing step (b) to (c) on one or more occasions, so that subject adherence to said regimen is enhanced.

19. The system of claim 18, wherein adherence to said regimen by said subjects receiving said survey prompt is at least 20 percent greater as compared to control subjects assigned the same regimen who do not receive said survey prompt.

20. The system of claim 18, wherein said regimen is a treatment regimen for a condition with which said subject is afflicted.

21. The system of claim 18, wherein said regimen is carried out once or twice daily for at least 4 weeks.

22. The system of claim 18, wherein said survey schedule is once or twice weekly for 4 to 8 weeks.

23. The system of claim 18, wherein said transmitting a survey prompt is carried out by automated transmission of an internet or telephone message.

24. The system of claim 18, wherein said of receiving a survey response is carried out by automated processing of an internet or telephone survey.

25. The system of claim 18, wherein said assigning further comprises: alerting each of said subjects of the availability of said reward.

26. The system of claim 18, further comprising:
(e) means for determining from said survey responses those subjects who have completed said internet-based survey in at least a predetermined number of occasions; and
(f) means for notifying those subjects who have completed said survey on at least said predetermined number of occasions of their receipt of a first reward.

27. The system of claim 18, wherein said survey includes at least one question concerning a side-effect, said question optionally having associated therewith a graphical depiction of said side-effect, said graphical depiction optionally having associated therewith a statement concerning the severity of the side-effect in said graphical depiction.

28. The system of claim 27, wherein said side-effect is skin irritation.

29-30. (canceled)
